(19) United States
(12) Patent Application Publication
(10) Pub. No.: US 2004/0165123 A1
(43) Pub. Date: Aug. 26, 2004

(54) Liquid crystal display device and an electromagnetic wave absorbing device

(76) Inventors: Atsumu Iguchi, Mobara (JP); Ikuko Nagayama, Chiba (JP); Iwao Takemoto, Mobara (JP); Masanori Ootawa, Oohara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/771,314

(22) Filed: Feb. 5, 2004

(30) Foreign Application Priority Data
Feb. 6, 2003 (JP) 2003-029247
Dec. 9, 2003 (JP) 2003-410279

(51) Int. Cl. G02F 1/1333

(52) U.S. Cl. 349/58

(57) ABSTRACT

The present invention provides a liquid crystal display device for a projector which exhibits an excellent moisture resistance and a heat radiation property. The liquid crystal display device for a projector includes at least a liquid crystal panel which forms respective substrates which are arranged to face each other with liquid crystal therebetween into an envelop and a package which mounts the liquid crystal panel thereon, and the package is formed of a metal body which forms a recessed portion in one surface thereof and the liquid crystal panel is mounted in the recessed portion.

### BACKGROUND OF THE INVENTION

1. Field of the Invention

The present invention relates to a liquid crystal display device for a projector.

2. Description of the Related Art

A liquid crystal display device for a projector projects an image from the liquid crystal display device and displays the image on a screen after magnifying the image with a lens and hence, the liquid crystal display device per se is configured in an extremely miniaturized shape compared to other usual liquid crystal display device.

That is, out of respective substrates which are arranged to face each other in an opposed manner with liquid crystal therebetween, one substrate is formed of a silicon substrate. In each pixel formed on a liquid-crystal-side surface of the silicon substrate, an electrode, an active element, signal lines and the like are incorporated by a so-called semiconductor technique. Then, due to electric fields which are generated in respective pixels, optical transmissivities of liquid crystals of respective pixels can be independently controlled.

Further, the electrode also has a function of a reflection film. By making light incident from another substrate side reflected on the electrode, a quantity of light which passes through the liquid crystal is made to be irradiated to the above-mentioned another substrate side.

Here, with respect to the liquid crystal display device having such a constitution, light from a light source of high temperature which is arranged close to the liquid crystal display device is incident on the liquid crystal display device and hence, the liquid crystal display device is requested to exhibit the excellent moisture resistance and the excellent heat radiation property.

The conventional liquid crystal display device of this type is constituted such that a cavity portion which houses a liquid crystal panel using respective substrates arranged to face each other with liquid crystal therebetween as an envelope is formed using a plastic molded part having the high degree of freedom in forming and a back surface of the plastic molded part is covered with a metal press part for radiation of heat.

However, plastic has a large thermal expansion coefficient compared to glass or silicon and hence, a stress is applied to a liquid crystal panel due to the difference in the thermal expansion coefficient thus giving rise to a drawback that so-called display irregularities (brightness irregularities) are liable to be easily generated.

Further, the package which is constituted of the plastic molded part and the metal press part has the multi-piece structure and hence, the number of adhesion surfaces is increased thus providing the constitution which exhibits poor assembling efficiency and the insufficient moisture resistance.

The present invention has been made under such circumstances and it is an object of the present invention to provide a liquid crystal display device for a projector which exhibits the high moisture resistance and the excellent radiation of heat.

It is another object of the present invention to provide an electromagnetic wave absorbing member which can be extremely suitably mounted on a liquid crystal display device for a projector.

### SUMMARY OF THE INVENTION

To briefly explain the summary of the representative inventions among inventions disclosed in this specification, they are as follows.

Means 1.

A liquid crystal display device for a projector according to the present invention is, for example, characterized in that the liquid crystal display device includes at least a liquid crystal panel which forms an envelope using respective substrates which are arranged to face each other with liquid crystal therebetween, and a package on which the liquid crystal panel is mounted, wherein the package is constituted of a metal body which forms a recessed portion in one surface thereof and the liquid crystal panel is mounted in the inside of the recessed portion.

Means 2.

A liquid crystal display device for a projector according to the present invention is, for example, characterized in that the liquid crystal display device includes at least a liquid crystal panel which forms an envelope using respective substrates which are arranged to face each other with liquid crystal therebetween, and a package on which a liquid crystal panel is mounted, wherein the package is constituted of a metal body which forms a recessed portion in one surface thereof, the liquid crystal panel is mounted in the inside of the recessed portion, and the liquid crystal panel is provided with an opening in a liquid crystal display part formed at a center portion thereof excluding a peripheral portion thereof and is sealed by a light shielding frame glass which is fixedly mounted on a surface of the package.

Means 3.

The liquid crystal display device for a projector according to the present invention is, for example, on the premise of the constitution of means 1 or means 2, characterized in that the metal body of the package is made of Kovar.

Means 4.

The liquid crystal display device for a projector according to the present invention is, for example, on the premise of the constitution of means 1 or means 2, characterized in that the metal body of the package is made of a 42 alloy.

Means 5.

The liquid crystal display device for a projector according to the present invention is, for example, on the premise of the constitution of means 2, characterized in that fixed mounting of the light shielding frame glass to a package is performed by hermetic sealing.

Means 6.

A liquid crystal display device for a projector according to the present invention is, for example, characterized in that the liquid crystal display device includes a liquid crystal panel which is mounted on a package and a printed circuit wiring board which is arranged to be pulled out from the liquid crystal panel, ferrite sheets are respectively provided to both sides of the printed circuit wiring board by adhesion, and a reflection film for electromagnetic waves is applied to a surface of each ferrite sheet at a side opposite to the printed circuit wiring board.

Means 7.

The liquid crystal display device for a projector according to the present invention is, for example, on the premise of the constitution of means 6, characterized in that a plurality of respective ferrite sheets are provided along the extension direction of wiring of the printed circuit wiring board.

Means 8.

The liquid crystal display device for a projector according to the present invention is, for example, on the premise of the constitution of means 6, characterized in that each reflection film against electromagnetic waves is made of metal such as aluminum or copper.

Means 9.

An electromagnetic wave absorbing member according to the present invention is, for example, characterized in that the electromagnetic wave absorbing member is constituted of a ferrite sheet and a reflection film against electromagnetic waves which is formed on one surface of the ferrite sheet.

Means 10.

An electromagnetic wave absorbing member according to the present invention is, for example, characterized by being constituted of a ferrite sheet, a reflection film against electromagnetic waves which is formed on one surface of the ferrite sheet, and a tacky adhesive tape which is adhered to another surface of the ferrite sheet.

Means 11.

The electromagnetic wave absorbing member according to the present invention is, for example, on the premise of the constitution of means 9 or 10, characterized in that each reflection film against electromagnetic waves is made of metal such as aluminum or copper.

In this specification, the present invention is not limited to the above-mentioned constitution and various modifications are conceivable without departing from the technical concept of the present invention.

### BRIEF DESCRIPTION OF THE DRAWINGS

FIG. 1 is comprised of constitutional views showing one embodiment of a liquid crystal display device for a projector according to the present invention, wherein FIG. 1A is a plan view, FIG. 1B is a front view and FIG. 1C is a side view;

FIG. 2 is a cross-sectional view taken along a line II-II in FIG. 1;

FIG. 3 is a constitutional view showing another embodiment of a liquid crystal display device for a projector according to the present invention and corresponds to FIG. 1;

FIG. 4 is a perspective view showing the detailed constitution of one embodiment of an electromagnetic wave absorbing member shown in FIG. 3; and

FIG. 5 is a graph showing an advantageous effect of the electromagnetic wave absorbing member according to the present invention.

### DESCRIPTION OF THE PREFERRED EMBODIMENTS

An embodiment of a liquid crystal display device for a projector according to the present invention is explained in conjunction with drawings hereinafter.

### Embodiment 1

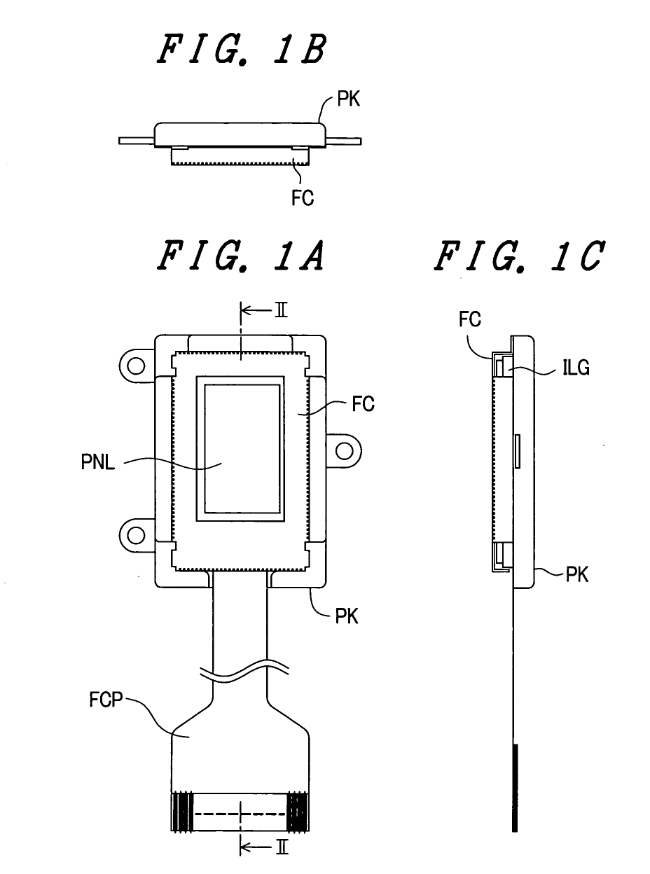

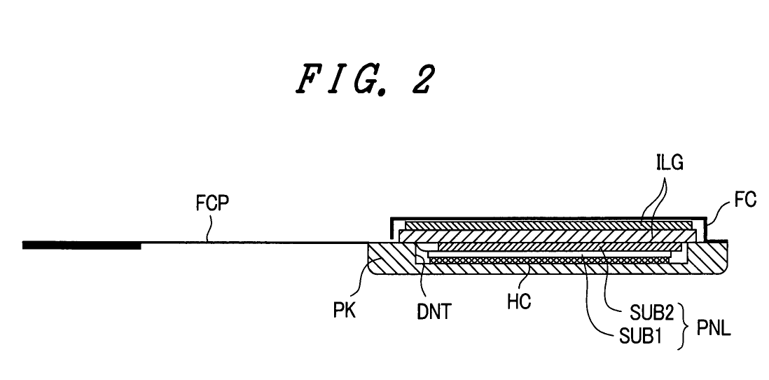

FIG. 1 is comprised of constitutional views showing one embodiment of a liquid crystal display device for a projector according to the present invention, wherein FIG. 1A is a plan view, FIG. 1B is a front view and FIG. 1C is a side view. Further, FIG. 2 is a cross-sectional view taken along a line II-II in FIG. 1A.

First of all, in these drawings, symbol PK indicates a package. The package PK is formed of a rectangular planar plate having a relatively large thickness and a recessed portion (a cavity) DNT having a shape approximately similar to a profile of the package PK is formed in one surface of the package PK.

The package PK provided with such a recessed portion DNT is formed by metal molding, for example.

A depth of the recessed portion DNT is determined such that when a liquid crystal panel PNL described later is mounted in the inside of the recessed portion DNT, a surface of the liquid crystal panel PNL becomes substantially coplanar with the surface of the package PK.

Further, the package PK is made of a material such as Kovar or a 42 alloy. Kovar is an alloy of Fe/Ni/Co (=54/29/17) and has a thermal expansion coefficient of approximately 44×10⁻⁷/° C. Further, the 42 alloy is an alloy of Fe/Ni (=58/42) and has a thermal expansion coefficient which is approximately equal to the thermal expansion coefficient of Kovar.

Here, to facilitate mounting of the package PK on other heat radiation plate or the like, a mounting portion for the heat radiation plate or the like is also integrally formed on the package PK.

In the inside of the recessed portion DNT of the package PK, the liquid crystal panel PNL is mounted by way of a heat sink compound HC. The heat sink compound HC is made of a soft material having a favorable thermal conductivity.

With respect to the liquid crystal panel PNL, one substrate SUB1 out of respective substrates which are arranged to face each other with liquid crystal therebetween is constituted of a silicon substrate. In each pixel formed on a liquid-crystal-side surface of the silicon substrate, electrodes, an active element and signal lines or the like are incorporated by a so-called semiconductor technique. Further, the electrodes also have a function of reflection films. Further, another substrate SUB2 is constituted of a light transmitting substrate made of glass or the like, for example.

Light from a light source incorporated into a projector is irradiated through the substrate SUB2 and is reflected on the above-mentioned electrodes formed of a reflection film and is emitted through the substrate SUB2 again. In this case, the emitted light has a quantity of light corresponding to the optical transmissivity of liquid crystal in each pixel.

Here, the liquid crystal panel PNL has a silicon-substrate (substrate SUB1) side thereof mounted on the package PK. This is because that the heat is generated at the silicon substrate side in which an electronic circuit is incorporated and the heat is radiated to the package PK through the above-mentioned heat sink compound HC.

Further, a flexible printed circuit wiring board FCP is connected to one side of the liquid crystal panel PNL, wherein the flexible printed circuit wiring board FCP is brought into contact with the surface (surface other than the recessed portion DNT) of the package PK and is pulled to the outside of the package PK.

The liquid crystal panel PNL which is mounted in the recessed portion DNT of the package PK is sealed in the inside of the recessed portion DNT by a light shielding frame glass ILG which is fixedly mounted on the surface (surface other than the recessed portion DNT) of the package PK.

The size of the light shielding frame glass ILG is determined slightly larger than the size of the recessed portion DNT. That is, the light shielding frame glass ILG is adhered to the package PK such that the light shielding frame glass ILG covers the recessed portion DNT. Here, the adhesion of the light shielding frame glass ILG is performed by hermetic sealing so as to prevent the intrusion of moisture into the inside of the recessed portion DNT through the adhered portion.

The light shielding frame glass ILG is provided for preventing the reflection of a periphery of a liquid crystal display part to a screen or for preventing the reflection of a foreign substance attached to a surface of a glass by defocusing the foreign substance.

Further, a front case FC made of metal such as copper is mounted on the package PK such that the front case FC covers the light shielding frame glass ILG. An opening (a display window) is formed in a portion of the front case FC which faces the liquid crystal display part arranged at a center portion of the liquid crystal panel PNL excluding the periphery thereof. The irradiation and the emission of light are performed through the opening.

In the liquid crystal display device for a projector having such a constitution, first of all, the package PK is formed of a metal body having the recessed portion DNT in which the liquid crystal panel PNL is mounted.

Accordingly, the package PK per se functions as a heat radiation plate. Further, a thickness of the package PK having the recessed portion DNT becomes inevitably large and this provision also can increase the heat radiation effect.

Accordingly, any forming which can increase a surface area of the package PK may be applied to a back surface of the package PK. That is, unevenness or a large number of grooves may be formed in the back surface of the package PK. With the provision of such forming, the heat radiation effect may be further increased.

Further, the package PK is configured such that the package PK faces all surfaces except for one surface (five surfaces) of the liquid crystal panel PNL in an opposed manner and hence, not to mention the enhancement of the heat radiation effect, a passage for intrusion of moisture can be narrowed and hence, the moisture resistance can be largely enhanced. In other word, this implies that it is sufficient to apply a countermeasure for moisture resistance to only the above-mentioned one surface of the liquid crystal panel PNL.

Further, the recessed portion DNT of the package PK also has a function of positioning the liquid crystal panel PNL in mounting the liquid crystal panel PNL and hence, the fixed mounting of the liquid crystal panel PNL to the package PK is achieved by merely performing the adhesion once whereby the manufacture of the liquid crystal display device can be simplified.

Further, the package PK is sealed by the light shielding frame glass ILG at a side thereof corresponding to one surface of the liquid crystal panel PNL which does not face the package PK, wherein as such a sealing, it is sufficient to perform sealing only by taking the moisture resistance between the light shielding frame glass ILG and the package PK. Accordingly, it is also possible to take the favorable or proper treatment with respect to the moisture resistance.

Further, the thermal expansion coefficient of the package PK is close to the thermal expansion coefficient of glass (38×10⁻⁷/° C.) which is a material of the substrates of the liquid crystal panel or the thermal expansion coefficient of silicon (41.5×10⁻⁷/° C.) which is also a material of the substrates of the liquid crystal panel and hence, the generation of stress in the liquid crystal panel PNL attributed to the difference in the thermal expansion coefficient can be minimized. Since the stress becomes a cause of display irregularities, the liquid crystal display device of this embodiment also has an advantageous effect that the display irregularities can be obviated.

### Embodiment 2

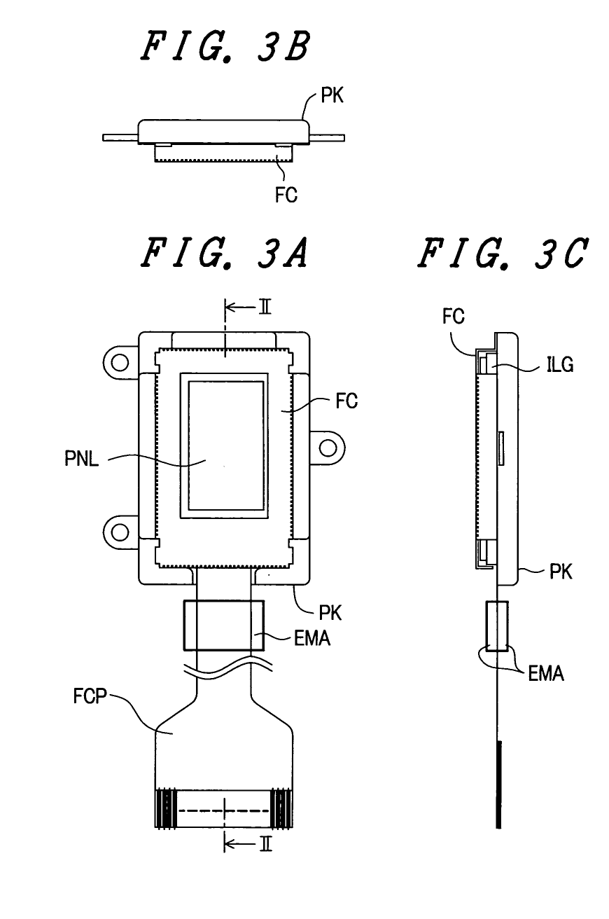

FIG. 3 is a constitutional view showing another embodiment of the liquid crystal display device for a projector according to the present invention and corresponds to FIG. 1.

The constitution which makes this embodiment different from the embodiment shown in FIG. 1 lies in a portion of the flexible printed circuit wiring board FCP. That is, in this embodiment, both sides of the flexible printed circuit wiring board FCP are covered with a pair of electromagnetic wave absorbing members EMA.

The electromagnetic wave absorbing members EMA are provided for absorbing electromagnetic waves generated from the flexible printed circuit wiring board FCP.

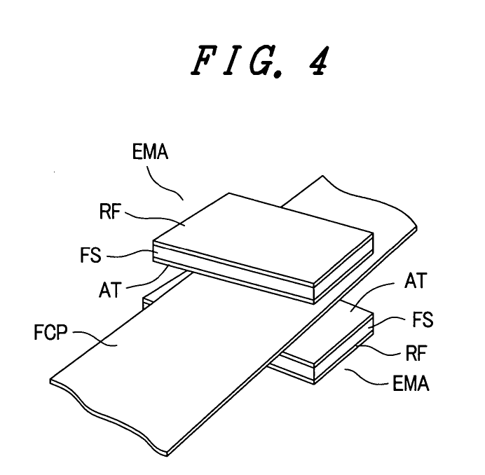

As shown in FIG. 4 which is a perspective view of the electromagnetic wave absorbing members EMA, in each electromagnetic wave absorbing member EMA, a base body is formed of a ferrite sheet FS. An adhesive tape AT is laminated to a surface of the ferrite sheet FS at a side which is adhered to the flexible printed circuit wiring board FCP to facilitate the adhesion of the ferrite sheet FS to the flexible printed circuit wiring board FCP. Further, an electromagnetic wave reflection film EMA is formed on a surface of the ferrite sheet FS at a side opposite to the adhesive tape AT.

The electromagnetic wave reflection film EMA functions as a reflection film against electromagnetic waves from the flexible printed circuit wiring board FCP. As a material of the electromagnetic wave reflection film EMA, an aluminum film is suitable. Further, the material of the electromagnetic wave reflection film EMA is not limited to the aluminum film and may be formed of a film made of metal such as copper or the like.

In such cases, the film may be formed of a film adhered to the corresponding device, a foil-like film laminated to the corresponding device or a film applied to the corresponding device by coating.

Although the similar advantageous effect may be obtained by using a usually known ferrite core without using the electromagnetic wave absorbing members EMA having the above-mentioned constitution, an advantageous effect obtained by the electromagnetic wave absorbing members EMA is larger than an advantageous effect obtained by the known ferrite core in degree. Further, the electromagnetic wave absorbing members EMA also has an advantageous that it is light-weighted.

Particularly, it is confirmed that the degree of electromagnetic wave absorption of the electromagnetic wave absorbing member EMA is three times as large as the degree of electromagnetic wave absorption of the ferrite core provided that a length of the electromagnetic wave absorbing member EMA in the longitudinal direction of the flexible printed circuit wiring board FCP is equal to a corresponding length of the ferrite core.

It can be estimated that the electromagnetic wave absorbing member EMA has a function of reflecting the electromagnetic waves which cannot be absorbed by the ferrite sheet FS toward the flexible printed wiring circuit board FCP side using the reflection film RE.

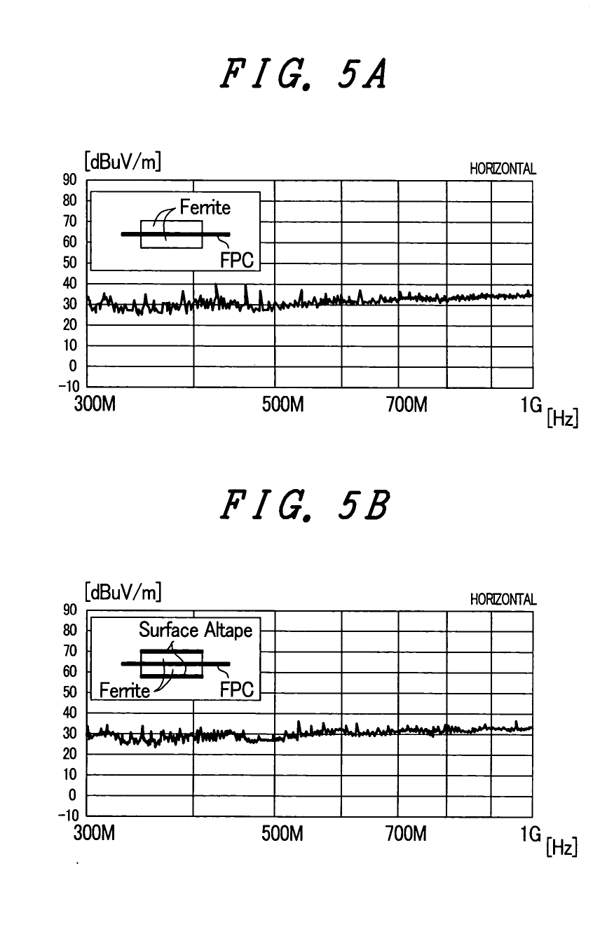

FIG. 5 is a graph of a result of an experiment in which electromagnetic wave absorbing members EMA each of which is formed of only a ferrite sheet FS which is not provided with a reflection film RE (FIG. 5A) and electromagnetic wave absorbing members EMA each of which is formed of a ferrite sheet FS which is provided with a reflection film RE (aluminum) (FIG. 5B) are respectively applied to the flexible printed circuit wiring board FCP as shown in FIG. 3 and the degree of absorption of electromagnetic waves is investigated.

It is understood that the absorption of electromagnetic waves of the ferrite sheet FS provided with the reflection film RE is performed in a substantially stable manner irrespective of frequency (an axis of abscissas) and the degree of absorption is large compared to the corresponding result obtained by the ferrite sheet FS provided with no reflection film RE.

It is needless to say that the length of the electromagnetic wave absorbing member EMA may be sufficiently elongated along the length of the flexible printed circuit wiring board FCP. This is because that corresponding to the elongated length of the electromagnetic wave absorbing member EMA, the electromagnetic wave absorbing effect can be increased. Further, different from the ferrite core, the ferrite sheet has the flexibility and there is no possibility that the flexibility of the flexible printed circuit wiring board FCP is damaged. In this case, it is also needless to say that a plurality of electromagnetic wave absorbing members EMA may be provided in the longitudinal direction of the flexible printed circuit wiring board FCP. This is because that a gap is defined between the respective electromagnetic wave absorbing members EMA so that the flexibility of the flexible printed circuit wiring board FCP can be improved.

Here, although the embodiment is explained in conjunction with the case in which the above-mentioned electromagnetic wave absorbing members EMA are used in the liquid crystal display device, it is needless to say that this embodiment is applicable to other electronic equipment which uses the above-mentioned flexible printed circuit wiring board.

In this case, the electromagnetic wave absorbing member EMA may be firstly formed as a member having a relatively large area and, thereafter, depending on the size of the flexible printed circuit wiring board on which the electromagnetic wave absorbing member EMA is mounted or portions of the flexible printed circuit wiring board where the electromagnetic wave absorbing member EMA is mounted, the electromagnetic wave absorbing member EMA are cut into a desired size freely and used.

The above-mentioned respective embodiments may be used in a single form or in combination. This is because the advantageous effects of respective embodiments can be obtained in a single form or in a synergistic manner.

What is claimed is:

1. A liquid crystal display device for a projector being characterized in that the liquid crystal display device includes at least a liquid crystal panel which forms an envelope using respective substrates which are arranged to face each other with liquid crystal therebetween, and a package on which the liquid crystal panel is mounted, and
the package is constituted of a metal body which forms a recessed portion in one surface thereof and the liquid crystal panel is mounted in the inside of the recessed portion.

2. A liquid crystal display device for a projector being characterized in that the liquid crystal display device includes at least a liquid crystal panel which forms an envelope using respective substrates which are arranged to face each other with liquid crystal therebetween, and a package on which the liquid crystal panel is mounted,
the package is constituted of a metal body which forms a recessed portion in one surface thereof,
the liquid crystal panel is mounted in the inside of the recessed portion, and
the liquid crystal panel is provided with an opening in a liquid crystal display part formed at a center portion thereof excluding a peripheral portion thereof and is sealed by a light shielding frame glass which is fixedly mounted on a surface of the package.

3. A liquid crystal display device for a projector according to claim 1, wherein the metal body of the package is made of Kovar.

4. A liquid crystal display device for a projector according to claim 1, wherein the metal body of the package is made of a 42 alloy.

5. A liquid crystal display device for a projector according to claim 2, wherein the fixed mounting of the light shielding frame glass to a package is performed by hermetic sealing.

6. A liquid crystal display device for a projector being characterized in that the liquid crystal display device includes a liquid crystal panel which is mounted on a package and a printed circuit wiring board which is arranged to be pulled out from the liquid crystal panel,
ferrite sheets are respectively provided to both sides of the printed circuit wiring board by adhesion, and
a reflection film for electromagnetic waves is applied to a surface of each ferrite sheet at a side opposite to the printed circuit wiring board.

7. A liquid crystal display device for a projector according to claim 6, wherein a plurality of respective ferrite sheets are provided along the extension direction of wiring of the printed circuit wiring board.

8. A liquid crystal display device for a projector according to claim 6, wherein each reflection film against electromagnetic waves is made of metal such as aluminum or copper.

9. An electromagnetic wave absorbing device being characterized in that the electromagnetic wave absorbing member is constituted of a ferrite sheet and a reflection film against electromagnetic waves which is formed on one surface of the ferrite sheet.

10. An electromagnetic wave absorbing device being characterized in that the electromagnetic wave absorbing member is constituted of a ferrite sheet, a reflection film against electromagnetic waves which is formed on one surface of the ferrite sheet, and a tacky adhesive tape which is adhered to another surface of the ferrite sheet.

11. An electromagnetic wave absorbing device according to claim 9 or claim 10, wherein each reflection film against electromagnetic waves is made of metal such as aluminum or copper.
